(19) United States
(12) Patent Application Publication
(10) Pub. No.: US 2025/0189749 A1
(43) Pub. Date: Jun. 12, 2025

(54) OPTICAL AXIS ADJUSTMENT METHOD AND APPARATUS

(71) Applicant: NEC Corporation, Tokyo (JP)

(72) Inventor: Hiroshi IMAI, Tokyo (JP)

(73) Assignee: NEC Corporation, Tokyo (JP)

(21) Appl. No.: 18/957,992

(22) Filed: Nov. 25, 2024

(30) Foreign Application Priority Data
Dec. 6, 2023 (JP) 2023-206195

(51) Int. Cl. G02B 7/00; G02B 26/10; H04B 10/11

(52) U.S. Cl. CPC G02B 7/003; G02B 26/101; H04B 10/11

(57) ABSTRACT

An optical axis adjustment apparatus includes: a deflector that deflects an incoming light beam to output an outgoing light beam to a target surface. The target surface includes a predetermined light-receiving location that is indicated by a predetermined figure displayed on the target surface. An image sensor captures the target surface through the deflector to output a captured image of the target surface. At least one processor extracts the predetermined figure from the captured image; detects the predetermined light-receiving location from the predetermined figure; and adjusts a deflection of the deflector so that the predetermined light-receiving location coincides with a reference location on the captured image of the target surface, wherein the reference location corresponds to a location of a primary optical axis of the incoming light beam on the captured image.

### INCORPORATION BY REFERENCE

The present application is based upon and claims the benefit of priority from Japanese Patent Application No. 2023-206195, filed on Dec. 6, 2023, the disclosure of which is incorporated herein in its entirety by reference.

### BACKGROUND

The present application relates to a method and apparatus for adjusting the optical axis of an optical beam to a light-receiving location. In the case of transmitting optical information through space, it is necessary to accurately illuminate the light-receiving section of a receiver with the light emitted from a transmitter. For this purpose, there have been proposed many techniques of aligning the optical axes between the transmitter and the receiver.

For example, according to patent literature 1 (Japanese Patent Application Publication No. JP2003-209520), the optical axis is roughly adjusted using wide-directivity infrared light before precisely adjusting the optical axis using narrow-directivity infrared light. Such optical axis adjustment is performed until the light-receiving level is not smaller than the predetermined intensity.

### SUMMARY

However, it is not easy to adjust the optical axis with high precision based on changes in the light-receiving level. The above-mentioned technique of the patent literature 1 requires two steps of optical axis adjustment to change the directivity of the transmission light. The high-precision and quick optical axis adjustment cannot be easily achieved.

Accordingly, an object of the present invention is to provide an optical axis adjustment method and apparatus that can easily achieve highly accurate and quick optical axis adjustment.

According to an illustrative embodiment of the disclosure, an optical axis adjustment apparatus includes: a deflector that deflects an incoming light beam to output an outgoing light beam to a target surface, wherein the target surface includes a predetermined light-receiving location that is indicated by a predetermined figure displayed on the target surface; an image sensor that captures the target surface through the deflector to output a captured image of the target surface; and at least one processor configured to: extract the predetermined figure from the captured image; detect the predetermined light-receiving location from the predetermined figure; and adjust a deflection of the deflector so that the predetermined light-receiving location coincides with a reference location on the captured image of the target surface, wherein the reference location corresponds to a location of a primary optical axis of the incoming light beam on the captured image.

According to an illustrative embodiment of the disclosure, an optical axis adjustment method in an optical axis adjustment apparatus including: a deflector that deflects an incoming light beam to output an outgoing light beam to a target surface, wherein the target surface includes a predetermined light-receiving location that is indicated by a predetermined figure displayed on the target surface; an image sensor that captures the target surface through the deflector to output a captured image of the target surface; and at least one processor configured to control the deflector based on the captured image, the method includes: extracting the predetermined figure from the captured image; detecting the predetermined light-receiving location from the predetermined figure; and adjusting a deflection of the deflector so that the predetermined light-receiving location coincides with a reference location on the captured image of the target surface, wherein the reference location corresponds to a location of a primary optical axis of the incoming light beam on the captured image.

According to an illustrative embodiment of the disclosure, a non-transitory recording medium storing a computer-readable program for an optical axis adjustment apparatus including: a deflector that deflects an incoming light beam to output an outgoing light beam to a target surface, wherein the target surface includes a predetermined light-receiving location that is indicated by a predetermined figure displayed on the target surface; an image sensor that captures the target surface through the deflector to output a captured image of the target surface; and at least one processor configured to control the deflector based on the captured image, the program includes instructions to: extract the predetermined figure from the captured image; detect the predetermined light-receiving location from the predetermined figure; and adjust a deflection of the deflector so that the predetermined light-receiving location coincides with a reference location on the captured image of the target surface, wherein the reference location corresponds to a location of a primary optical axis of the incoming light beam on the captured image.

As described above, according to the illustrative embodiments, highly accurate and quick optical axis adjustment can be easily achieved.

### BRIEF DESCRIPTION OF THE DRAWINGS

FIG. 1 is a schematic diagram illustrating the configuration of an optical axis adjustment apparatus according to a first example embodiment of the present invention.

FIG. 2 is a schematic block diagram illustrating the functional configuration of a processor in the first example embodiment.

FIG. 3 is a flowchart illustrating the optical axis adjustment method of the processor in the first example embodiment.

FIG. 4 is a schematic diagram showing an example of the optical axis adjustment operation of the processor in the first example embodiment.

FIG. 5 is a schematic diagram illustrating the state of the optical axis adjustment apparatus after completing the optical axis adjustment in the first example embodiment.

FIG. 6 is a schematic diagram illustrating the configuration of an optical axis adjustment apparatus according to a second example embodiment of the present invention.

FIG. 7 is a schematic diagram illustrating the relationship among two figures to be captured, their respective formed images, and an image-forming optical system in the optical axis adjustment apparatus according to the second example embodiment.

FIG. 8 is a schematic block diagram illustrating the functional configuration of a processor in the second example embodiment.

FIG. 9 is a flowchart illustrating the optical axis adjustment method of the processor in the second example embodiment.

FIG. 10 is a schematic diagram illustrating the configuration of an optical axis adjustment apparatus according to a first example of the present invention.

FIG. 11 is a schematic diagram illustrating the relationship among two figures to be captured, their respective formed images, and the image forming optical system in the optical axis adjustment apparatus according to the first example.

FIG. 12 is a schematic block diagram illustrating an example of a communication system to which the optical axis adjustment apparatus according to a second example of the present invention is applied.

FIG. 13 is a schematic diagram illustrating the configuration of an optical axis adjustment apparatus according to a third example of the present invention.

FIG. 14 is a schematic diagram illustrating the configuration of an optical axis adjustment apparatus according to a fourth example of the present invention.

FIG. 15 is a schematic diagram illustrating a deflector used in the above-described example embodiments and examples of the present invention.

### DETAILED DESCRIPTION

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

### OVERVIEW OF EXAMPLE EMBODIMENTS

According to example embodiments of the present invention, the light-receiving location to be irradiated with a light beam can be identified based on a predetermined figure. By capturing the predetermined figure, the light-receiving location can be detected from the captured image of the predetermined figure. The deflection direction of the light beam is adjusted so that a reference position indicating the optical axis of the light beam is placed on the light-receiving position. Accordingly, the optical axis can be adjusted based on the captured figure at the transmitting side without the need to monitor the intensity of light received at the receiving side, which can achieve highly accurate and quick optical axis adjustment.

Example embodiments and examples of the present invention will be described in detail below with reference to the drawings. However, the components described in the following example embodiments and examples are merely examples, and are not intended to limit the technical scope of the invention to them alone.

### 1. First Example Embodiment

### 1.1) Configuration

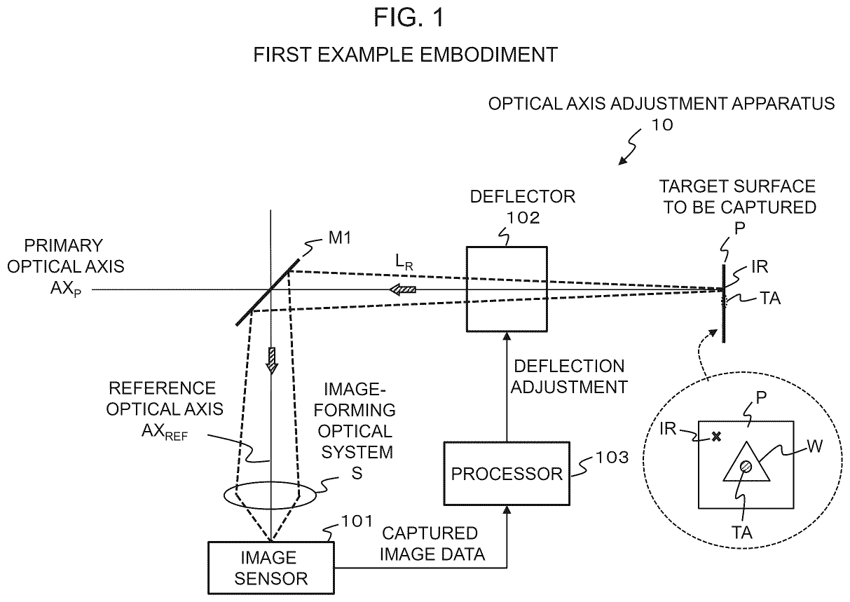

As illustrated in FIG. 1, an optical axis adjustment apparatus 10 according to a first example embodiment of the present invention includes: an image capturing section including an image sensor 101, an image-forming optical system S and a mirror member M1; a deflector 102 that can deflect the primary optical axis AX_{P} of a transmission light beam to desired angular positions; and a processor 103 for adjusting the deflection of the deflector 102 based on image data captured by the image sensor 101.

The image sensor 101 is a two-dimensional sensor having an light-receiving surface which is placed on the imaging plane of the image-forming optical system S. Light from a surface P to be captured (hereinafter, referred to as “target surface P”) is reflected by the mirror member M1 through the deflector 102 and forms an image of the target surface P on the image sensor 101 through the image-forming optical system S. The deflector 102 may be a mechanically driven, acousto-optic or electro-optic deflector which can control deflection of the light beam in a desired direction and angle. A galvanometer scanner may be employed as an example of the deflector 102. The processor 103 may include at least one processing unit that can be configured by programs to implement deflection control. The processor 103 may include at least one CPU (Central Processing Unit) or the like.

Referring to FIG. 1, the primary optical axis AX_{P} is the central axis of the optical beam entering the deflector 102 from a laser source (not shown). A reference optical axis AX_{REF} is orthogonal to the primary optical axis AX_{P}. The mirror member M1 is, for example, a dichroic mirror. In this example embodiment, the center of the mirror member M1 is positioned on the intersection of the primary optical axis AX_{P} and the reference optical axis AX_{REF}. The semi-reflective surface of the mirror member is inclined 45 degrees clockwise from the reference optical axis AX_{REF}. The mirror member M1 has the optical characteristics such that a light beam of a predetermined wavelength λ1 is transmitted, whereas light of other wavelengths λ2 (in this case, light L_{R} reflected from the surface P) is reflected in the direction of the reference optical axis AX_{REF}.

The mirror member M1 and deflector 102 are arranged so that their optical axes are aligned with the primary optical axis AX_{P}. The mirror member M1, image-forming optical system S, and image sensor 101 are positioned so that their optical axes are aligned with the reference optical axis AX_{REF}. It is assumed that the location of the reference optical axis AX_{REF} on the light-receiving surface of the image sensor 101 corresponds to the location of the primary optical axis AX_{P}. In other words, the location of the reference optical axis AX_{REF} can be treated as the location of the primary optical axis AX_{P} in the image captured by the image sensor 101.

Light L_{R} of wavelength λ2 reflected from the target surface P enters the mirror member M1 through the deflector 102. The light L_{R} reflected by the mirror member M1 forms an image on the light-receiving surface of the image sensor 101 through the image-forming optical system S. Therefore, the image of the target surface P is formed on the light-receiving surface of the image sensor 101, which outputs the captured image data to the processor 103. In other words, the image sensor 101 images the target surface P through the deflector 102 and the image-forming optical system S.

A predetermined figure W is displayed on the target surface P. The predetermined figure W may be a figure that can geometrically identify the light-receiving window TA as the irradiation target of the light beam. As an example of displaying methods, it is preferable that the predetermined figure W is printed with a reflective material (retroreflective material). As another example, a plurality of light emitting elements may be arranged in the shape of the predetermined figure W. In FIG. 1, the predetermined figure W is shown as a triangle for convenience to distinguish it from other figures. The predetermined figure W may employ any shape that can identify the light-receiving window TA. It is desirable to use a shape that is easy to extract. For example, it is desirable to use simple lines, such as a shape that surrounds or indicates the light-receiving window TA with only straight lines, a shape that crosses two straight lines, or a circular shape. FIG. 1 illustrates a state in which an apparent irradiation location IR of the light beam does not coincide with the light-receiving window TA of the target surface P without deflection adjustment by the deflector 102.

It should be noted that the target surface P may be illuminated by illumination light of wavelength λ2, which will be described below. As an illumination method, an illumination light source of wavelength λ2 may be placed near the surface P, or a light beam for illumination may be irradiated onto the surface P along the primary optical axis AX_{P}. It is preferable that the image sensor 101 has relatively high sensitivity only to light of wavelength λ2.

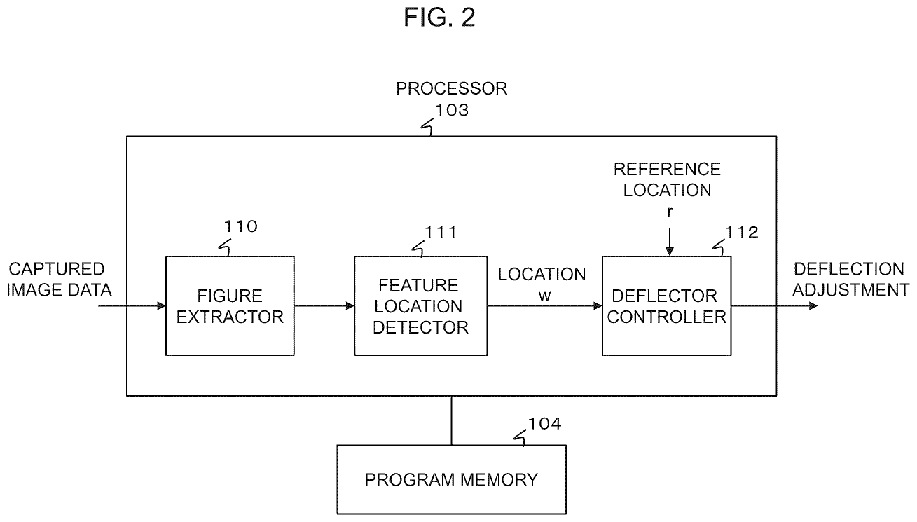

As illustrated in FIG. 2, the processor 103 executes programs stored in a program memory 104 to realize an optical axis adjustment function by a figure extractor 110, feature location detector 111, and deflector controller 112. The figure extractor 110 performs image transformation processing on image data captured by the image capturing section to extract the predetermined figure W. For example, linear or circular elements may be easily detected by Hough transform.

The feature location detector 111 detects the feature location indicating the light-receiving window TA from the extracted predetermined figure W. The deflector controller 112 controls the deflector 102 so as to cancel the difference between the given reference location r and the feature location indicating the light-receiving window TA. As already mentioned, the reference location r in the captured image indicates the location of the primary optical axis AX_{P} on the captured image. This reference location r may be determined in advance by positioning the mirror member M1, image-forming optical system S and image sensor 101 relative to the primary optical axis AX_{P} and the reference optical axis AX_{REF}.

### 1.2) Operation

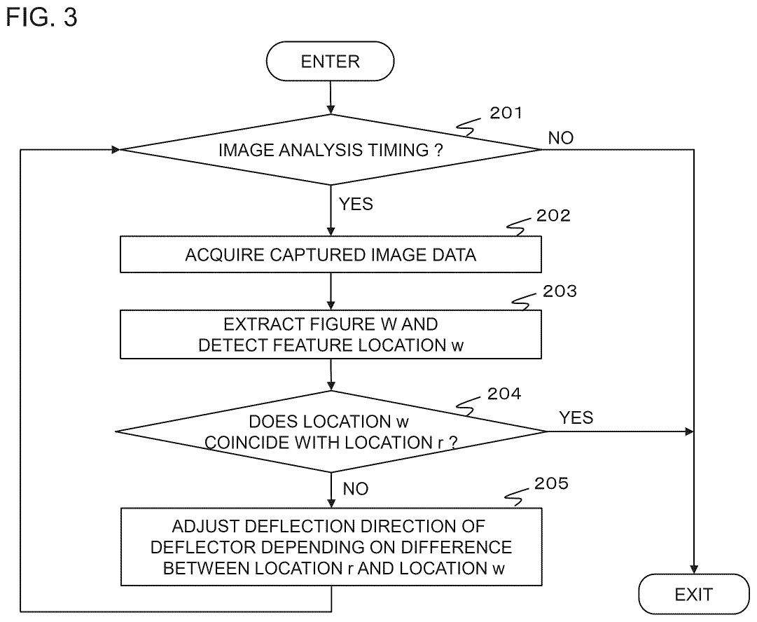

An optical axis adjustment method performed by the processor 103 will be described below with reference to FIGS. 3-5.

Referring to FIG. 3, the processor 103 determines whether it is image analysis timing (operation 201). If it is image analysis timing (YES in operation 201), the processor 103 acquires captured image data of the target surface P from the image sensor 101 (operation 202). This captured image includes an image of the predetermined figure W on the target surface P.

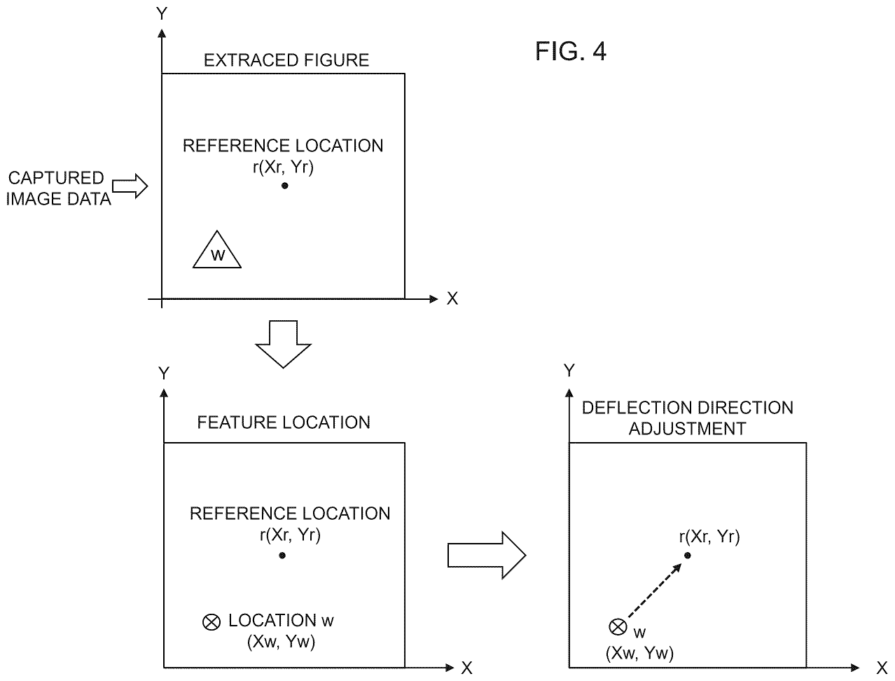

The processor 103 extracts the shape of the predetermined figure W from the captured image of the target surface P by, for example, Hough transform. The processor 103 geometrically detects the feature location w from the extracted figure (operation 203). FIG. 4 shows an example of the extraction of figure W and the detection of feature location w from the figure W. In the case where the captured image is developed in the XY plane, it is assumed that the reference location r of the reference optical axis AX_{REF} corresponding to the primary optical axis AX_{P} is indicated by predetermined coordinates (Xr, Yr) and the detected feature location w is indicated by coordinates (Xw, Yw).

Subsequently, the processor 103 determines whether the coordinates (Xw, Yw) of the detected feature location w coincides with the coordinates (Xr, Yr) of the reference location r (operation 204). Here, “coincide with” means that the difference between the feature location w and the reference location r is smaller than a predetermined threshold value. This predetermined threshold may be set to a range where the light beam fully illuminates the light-receiving window TA without problems in operations of the system.

If the feature location w and the reference location r do not coincide with one another (NO in operation 204), the processor 103 adjusts the deflection of the deflector 102 to cancel the difference between the coordinates (Xw, Yw) of the feature location w and the coordinates (Xr, Yr) of the reference location r (operation 205). The above operations 202 to 205 are repeated at each image analysis timing, but are not performed if it is not an image analysis timing (NO in operation 201). If the coordinates of the feature location w and the coordinates of the reference location r are identical (YES in operation 204), the operation 205 (deflection adjustment) is not performed.

After adjusting the deflection of the deflector 102, the processor 103 may rerun operations 202-204 to check whether the difference between the feature location w and the reference location r is sufficiently reduced. If the difference exceeds a predetermined threshold, the deflection adjustment may be repeated by operation 205.

The image analysis timing in operation 201 may be set according to an optical system to which the optical axis alignment apparatus is applied. For example, in an optical communication system using quantum light, it is necessary to accurately align optical beams for communication at the transmitting and receiving sides. If the amount of light incident on the receiving side fluctuates due to vibration of communication devices, the optical axes can be adjusted at near real-time timing by shortening the interval of image analysis timing.

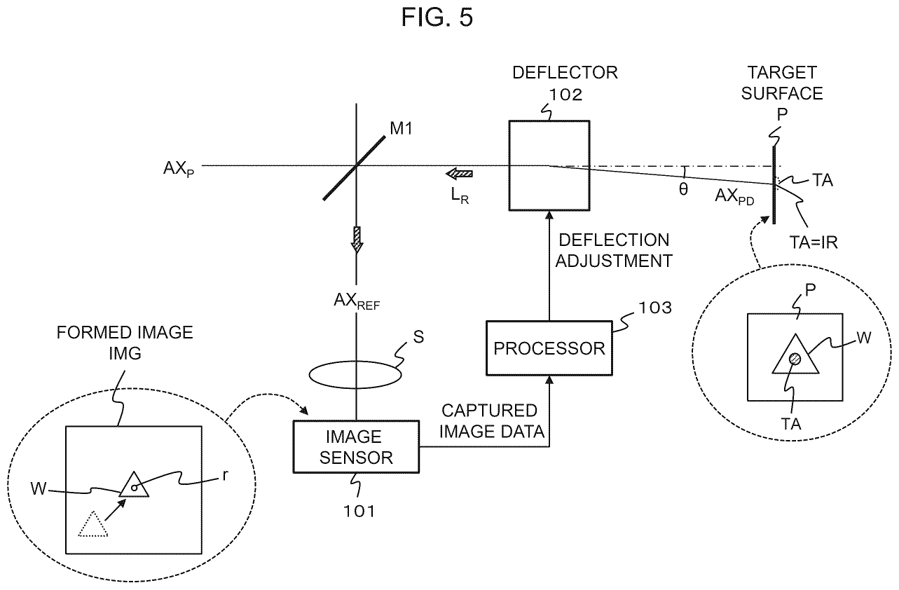

In FIGS. 4 and 5, if the coordinates (Xw, Yw) of the detected feature location w do not coincide with the coordinates (Xr, Yr) of the reference location r, the irradiation location of the light beam along the current primary optical axis AX_{P} falls out of the location w of the light receiving window TA which is the irradiation target.

When the coordinates of the feature location w do not coincide with those of the reference location r, the processor 103 calculates the difference between the coordinates (Xw, Yw) of the feature location w and the coordinates (Xr, Yr) of the reference location r, and determines the deflection direction and angle θ (angular position) of the deflector 102 to eliminate the difference. As illustrated in FIG. 5, assume that the processor 103 controls the deflector 102 to deflect the primary optical axis AX_{P} by an angle θ, and that the apparent irradiation location IR of the light beam at the primary optical axis AX_{PD} after deflection coincides with the light receiving window TA of the irradiation target. In this case, the center of the predetermined figure W overlaps with the reference location r in the formed image IMG on the image sensor 101. Accordingly, in this state, the coordinates (Xr, Yr) of the reference location r and the coordinates (Xw, Yw) of the detected feature location w coincide with one another on the XY plane of the captured image as shown in FIG. 4. In this manner, the optical axis adjustment is performed by controlling the deflector 102 so that the feature location w and the reference location r coincide with one another on the captured image.

### 1.3) Advantageous Effect

As described above, according to the first example embodiment of the present invention, the light-receiving location TA to be irradiated with the light beam can be identified based on the predetermined figure W. The image sensor 101 captures the predetermined figure W through the deflector 102, mirror member M1 and image-forming optical system S. From the captured image, the light-receiving location TA is detected from the predetermined figure W. The deflection of the deflector 102 is adjusted so that the light-receiving location TA coincides with the reference location r on the captured image. This enables optical axis adjustment based on the captured figure at the transmitting side of the light beam. Therefore, it is no longer necessary to monitor the amount of light received at the receiving side, and the optical axis can be adjusted quickly and precisely at the transmitting side.

### 2. Second Example Embodiment

In the first example embodiment as described above, the reference location r corresponding to the reference optical axis AX_{REF} is determined in advance on the captured image, but the present invention is not limited to the first example embodiment. As described below, the reference location r can be detected by the same procedure as the predetermined figure W using a figure that can identify the reference location r. Hereinafter, the configuration and function that differ mainly from those of the first example embodiment will be described. The same reference numbers will be employed for components similar to those of the first example embodiment and their explanations will be omitted.

### 2.1) Configuration

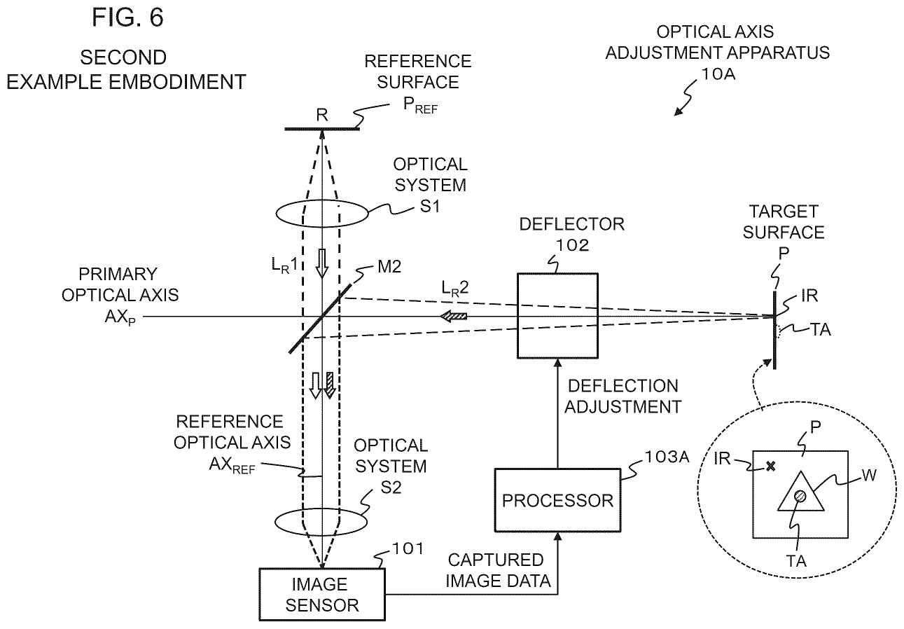

As illustrated in FIG. 6, an optical axis adjustment apparatus 10A according to the second example embodiment of the present invention includes an image capturing section including an image sensor 101, an optical system S1, and optical system S2, and a mirror member M2. Furthermore, the optical axis adjustment apparatus 10A includes a deflector 102 capable of deflecting the primary optical axis AX_{P} of a signal optical beam which is a laser beam; and a processor 103A that adjusts the deflection of the deflector 102 based on the captured image data input from the image sensor 101.

The primary optical axis AX_{P} has been described in the first example embodiment. The reference optical axis AX_{REF} is orthogonal to the primary optical axis AX_{P}. The mirror member M2 has its center on the intersection of the primary optical axis AX_{P} and the reference optical axis AX_{REF}, and its semi-reflective surface is inclined 45 degrees clockwise from the reference optical axis AX_{REF}. The mirror member M2 has optical characteristics such that a light beam of a predetermined wavelength λ1 is transmitted, whereas nearly half of light of other wavelengths λ2 is transmitted and the remaining half is reflected in the direction of the reference optical axis AX_{REF}. In this case, the light of other wavelengths λ2 is light L_{R}1 reflected from a reference surface P_{REF} or light L_{R}2 reflected from the target surface P). The mirror member M2 may be a single mirror composed of a dielectric multilayer film having such optical characteristics.

The mirror member M2 and deflector 102 are arranged so that their optical axes coincide with the primary optical axis AX_{P}. The mirror member M2, optical systems S1 and S2, and image sensor 101 are arranged so that their optical axes coincide with the reference optical axis AX_{REF}. As in the first example embodiment, the location of the reference optical axis AX_{REF} can be treated as the location of the primary optical axis AX_{P} in the captured image acquired by the image sensor 101.

The light L_{R}1 reflected from the reference surface P_{REF} falls upon the mirror member M2 along the reference optical axis AX_{REF} and is transmitted through the mirror member M2. The transmitted light L_{R}1 forms an image on the image sensor 101 through the optical system S2. Also, the light L_{R}2 reflected from the target surface P falls upon the mirror member M2 along the primary optical axis AX_{P} and is reflected by the mirror member M2 in the direction of the reference optical axis AX_{REF}. The reflected light L_{R}2 forms an image on the image sensor 101 through the optical system S2. In other words, the images of the reference surface P_{REF} and the target surface P are formed on the light-receiving surface of the image sensor 101. The image sensor 101 outputs the captured image data to the processor 103A. In other words, the image sensor 101 images the reference surface P_{REF} through the optical systems S1 and S2, and images the target surface P through the deflector 102 and the optical system S2.

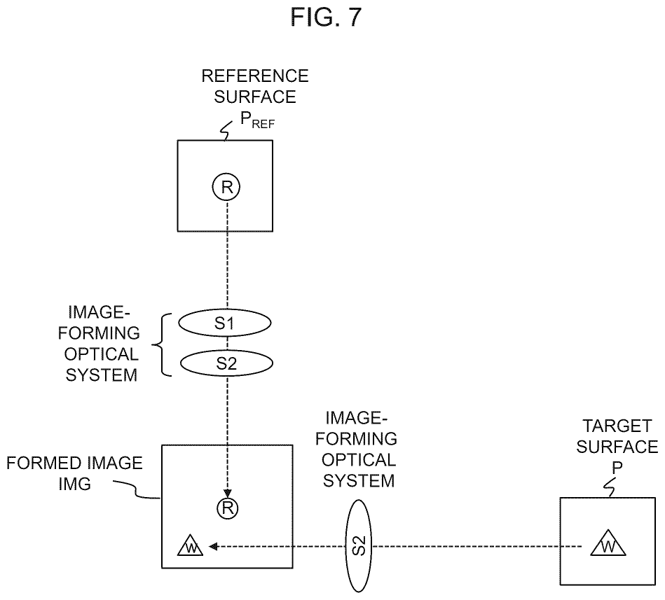

As illustrated in FIG. 7, a reference figure R is displayed on the reference surface P_{REF}. The reference figure R can be used to geometrically identify the reference location of the reference optical axis AX_{REF} corresponding to the primary optical axis of the light beam AX_{P}. As an example of displaying methods, it is preferable that the reference figure R may be printed with a reflective material (retroreflective material). Alternatively a plurality of light emitting elements may be arranged in the shape of the reference figure R. On the target surface P, as in the first example embodiment, a predetermined figure W is displayed that can be used to geometrically identify the light-receiving window TA, which is the irradiation target of the light beam. It is desirable that the reference figure R and the predetermined figure W are shaped to allow each figure to be extracted even if the reference location and the light-receiving window TA overlap one another. Specific examples are described below.

In FIG. 7, the reference figure R is shown as a circle for convenience to distinguish it from the predetermined figure W. The reference figure R is preferably shaped such that its shape can identify the location r of the reference optical axis AX_{REF} corresponding to the primary optical axis AX_{P}. As mentioned above, it is desirable that the reference figure R and the predetermined figure W are shaped to distinguish between their respective figures even if they are overlapped. For example, if the reference figure R is circular, the predetermined figure W may have a shape that consists only of straight lines surrounding the reference figure R and can indicate the light-receiving window TA.

As described below, it is preferable that the reference surface P_{REF} and the target surface P are illuminated with illumination light of wavelength λ2. As an illumination method, an illumination light source of wavelength λ2 may be placed in the vicinity of each of the reference surface P_{REF} and the target surface P. The light beam for illumination falls on the mirror member M2 along the primary optical axis AX_{P}, thereby illuminating the reference surface P_{REF} and the target surface P, respectively. It is preferable that the image sensor 101 has relatively high sensitivity only to light of wavelength λ2.

As shown in FIG. 7, the optical systems S1 and S2 are combined to constitute a single image-forming optical system focusing on the reference surface P_{REF}, thereby forming an image of the reference surface P_{REF} on the light-receiving surface of the image sensor 101. The optical system S2 also constitutes an image-forming optical system focusing on the target surface P, thereby forming an image of the target surface P on the light-receiving surface of the image sensor 101.

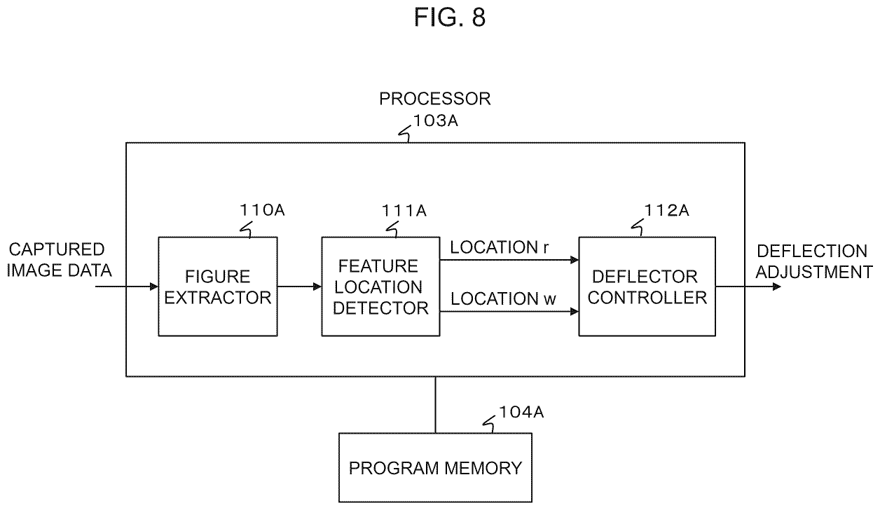

As illustrated in FIG. 8, the processor 103A executes a program stored in a program memory 104A to realize an optical axis adjustment function by a figure extractor 110A, feature location detector 111A, and deflector controller 112A. The figure extractor 110A performs image transformation processing on image data captured by the image capturing section to extract the reference figure R and the predetermined figure W. For example, Hough transform may be used to easily detect linear or circular elements.

The feature location detector 111A detects the reference location r from the extracted reference figure R and further detects the feature location w indicating the light-receiving window TA from the extracted predetermined figure W. The deflector controller 112A controls the deflector 102 so as to cancel the difference between the detected reference location r and the feature location w.

### 2.2) Operation

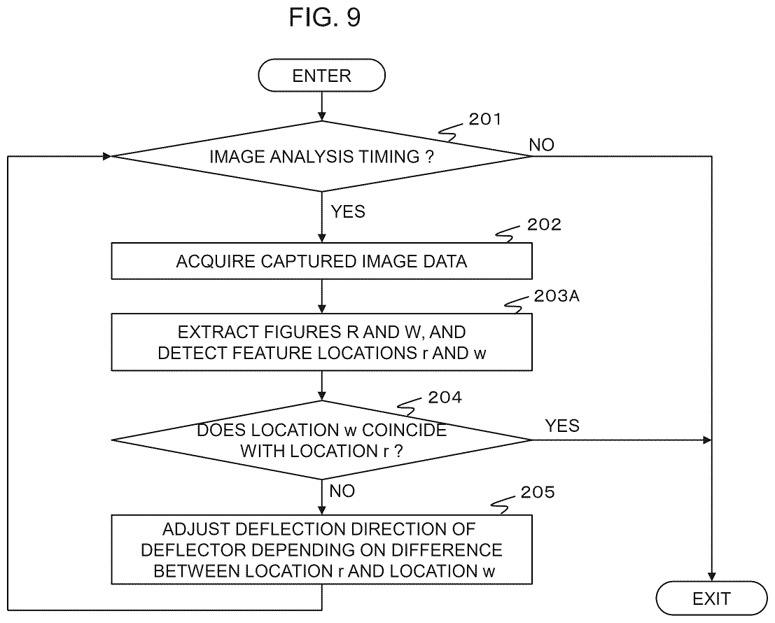

An optical axis adjustment method performed by the processor 103A will be described below according to FIG. 9 with appropriate reference to FIGS. 4 and 5.

Referring to FIG. 9, the processor 103A determines whether it is image analysis timing (operation 201). If it is image analysis timing (YES in operation 201), the processor 103A inputs image data from the image sensor 101 and acquires a captured image of the reference surface P_{REF} and the target surface P (operation 202). The captured image includes an image of the reference figure R of the reference surface P_{REF} and an image of the predetermined figure W of the target surface P.

The processor 103A extracts the shape of reference figure R from the acquired image of the reference surface P_{REF} and the shape of predetermined figure W from the acquired image of the target surface P by, for example, Hough transform. The processor 103A geometrically detects the reference location r and the feature location w from the extracted reference figure R and predetermined figure W, respectively (operation 203A). As illustrated in FIG. 4, when the captured image is developed in the XY plane, it is assumed that the detected reference location r is indicated by coordinates (Xr, Yr) and the detected feature location w is indicated by coordinates (Xw, Yw).

Subsequently, the processor 103A determines whether the coordinates (Xw, Yw) of the detected feature location w coincide with the coordinates (Xr, Yr) of the reference location r (operation 204). If the feature location w and the reference location r do not coincide with one another (NO in operation 204), the processor 103A adjusts the deflection of the deflector 102 to eliminate the difference between the coordinates (Xw, Yw) of the feature location w and the coordinates (Xr, Yr) of the reference location r (operation 205).

The deflection adjustment of deflector 102 has been described in FIG. 5. The processor 103A controls the deflector 102 to deflect the primary optical axis AX_{P} by an angle θ in a deflection direction to eliminate the difference between the feature point location w and the reference location r. This allows the apparent irradiation location IR of the light beam along the deflected primary optical axis AX_{PD} to coincide with the light-receiving window TA of the irradiation target. In this way, optical axis adjustment is executed.

The above-mentioned operations 202 to 205 are repeated at each image analysis timing, but are not performed if it is not an image analysis timing (NO in operation 201). If the coordinates of the feature location w and the coordinates of the reference location r are identical (YES in operation 204), the operation 205 (deflection adjustment) is not performed. The definition of “coincide with” is as described in the first example embodiment.

After adjusting the deflection direction of the deflector 102, the processor 103A may rerun operations 202-204 to check whether the difference between the feature location w and the reference location r is sufficiently reduced. If the difference exceeds a predetermined threshold, the deflection adjustment may be repeated by operation 205.

The image analysis timing in operation 201 may be set according to an optical system to which the optical axis alignment system is applied. For example, in an optical communication system using quantum light, it is necessary to accurately align optical beams for communication at the transmitting and receiving sides. If the amount of light incident on the receiving side fluctuates due to vibration of communication devices, the optical axes can be adjusted at near real-time timing by shortening the interval of image analysis timing.

### 2.3) Advantageous Effect

As described above, according to the second example embodiment of the present invention, the position of the reference optical axis AX_{REF} corresponding to the primary optical axis AX_{P} of the light beam can be identified based on the reference figure R. The light receiving location TA to be illuminated by the light beam can be identified based on the predetermined figure W. The image sensor 101 captures the reference figure R through the optical system S1, mirror member M2 and optical system S2, and captures the predetermined figure W through the deflector 102, mirror member M2 and optical system S2. From the captured image, the reference location r is detected based on the reference figure R, and the light-receiving location TA is detected based on the predetermined figure W. The deflection of the deflector 102 is adjusted so that the light-receiving location TA coincides with the reference location r in the captured image. In this manner, the optical axis adjustment can be performed based on the detected figures at the transmitting side of the light beam. Accordingly, it is no longer necessary to monitor the amount of light received at the receiving side, and the optical axis adjustment can be performed quickly and precisely at the transmitting side.

Furthermore, according to the second example embodiment, the reference surface P_{REF} is captured through the optical system S1, mirror member M2 and optical system S2 to detect the reference location r. Accordingly, the location of the reference optical axis AX_{REF} can be correctly detected as a whole even if misalignments occur due to vibration or the like in the optical axis adjustment apparatus 10A exclusive of the target surface P.

### 3. First Example

In the first and second example embodiments described above, it is desirable to illuminate the target surface P or both the reference surface P_{REF} and the target surface P with illumination light of wavelength λ2. The illumination means in the optical axis adjustment apparatus according to the second example embodiment described above will be described below. Hereinafter, the configuration and functions different from those of the second example embodiment will be mainly described. Components similar to those of the second example embodiment are denoted by the same reference numerals and their descriptions will be omitted.

### 3.1) First Example

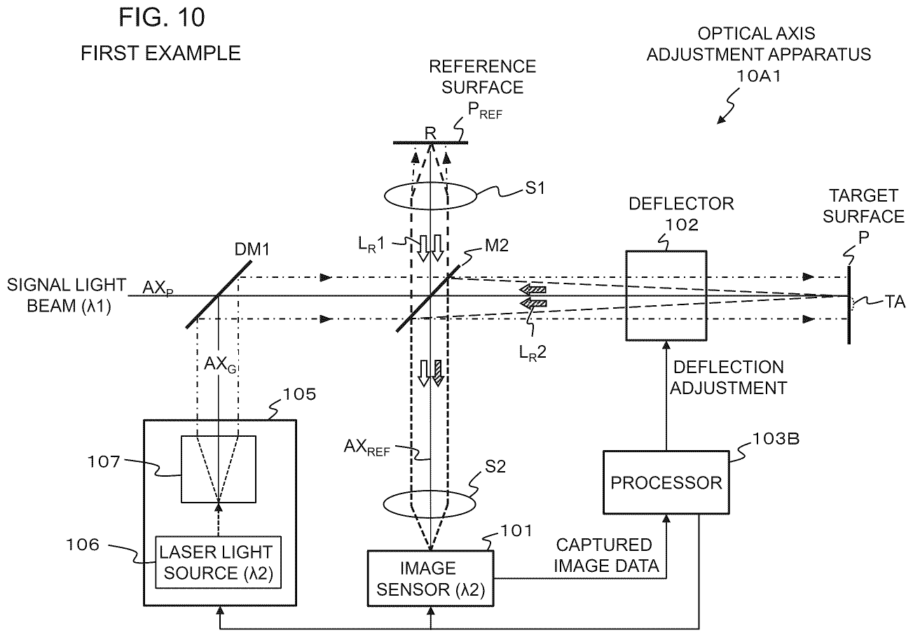

As illustrated in FIG. 10, the optical axis adjustment apparatus 10A1 according to the first example has a configuration such that an illumination light generator 105 and dichroic mirror DM1 are added to the configuration of optical axis adjustment apparatus 10A according to the second example embodiment (see FIG. 6).

The illumination light generator 105 includes a laser light source 106 of wavelength λ2 and a beam expander 107. The laser light source 106 outputs an optical beam of wavelength λ2 to the beam expander 107. The beam expander 107 outputs a collimated light beam as an illumination light beam with a diameter larger than the input light beam to the dichroic mirror DM1. The optical axis AX_{G} of the illumination light generator 105 is orthogonal to the primary optical axis AX_{P}. The dichroic mirror DM1 is placed at the intersection of the primary optical axis AX_{P} and the optical axis AX_{G}.

The semi-reflective surface of the dichroic mirror DM1 is inclined 45 degrees clockwise with respect to the optical axis AX_{G}. The dichroic mirror DM1 has optical characteristics such that a signal light beam of wavelength A1 is transmitted, whereas an illumination light beam of wavelengths λ2 different from the wavelength λ1 is reflected.

The illumination light beam is reflected by the dichroic mirror DM1 and travels in the direction of the primary optical axis AX_{P}, thereby illuminating the target surface P through the mirror member M2 and deflector 102. The illumination light beam is also reflected by the mirror member M2 and travels in the direction of the reference optical axis AX_{REF}, thereby illuminating the reference surface P_{REF} through the optics S1. As described above, the reference figure R and predetermined figure W are printed with the retroreflective material on the reference surface P_{REF} and the target surface P, respectively.

The reflected light L_{R}1 from the reference surface P_{REF} passes through the optical system S1 and the mirror member M2 and further passes through the optical system S2 to form the reference figure R on the light-receiving surface of the image sensor 101. The reflected light L_{R}2 from the target surface P is transmitted through the deflector 102 and reflected from the mirror member M2 to the optical system S2, through which the predetermined figure W is formed on the light-receiving surface of the image sensor 101. Accordingly, the image sensor 101 outputs the image data of the reference surface P_{REF} and the target surface P to the processor 103B, which controls the deflection of the deflector 102 to perform the above-described optical axis adjustment.

Furthermore, the processor 103B can control the timing of the illumination light beam emitted from the illumination light generator 105. That is, the laser light source 106 is driven to emit the illumination light beam only at the image analysis timing as described above. Thereby, the reference surface P_{REF} and the target surface P are illuminated, and the optical axis can be adjusted based on their reflected light L_{R}1 and reflected light L_{R}2. Alternatively, by constantly driving the laser light source 106 to illuminate the reference surface P_{REF} and the target surface P, the optical axis correction can be performed in real time, allowing more fine optical axis adjustment.

The illumination light beam from the illumination light generator 105 is reflected by the dichroic mirror DM to illuminate the target surface P in the direction of the primary optical axis AX_{P}. Accordingly, the illumination light beam illuminating the target surface P can be used as guide light, especially in the case where the deflector 102 is adjusted manually.

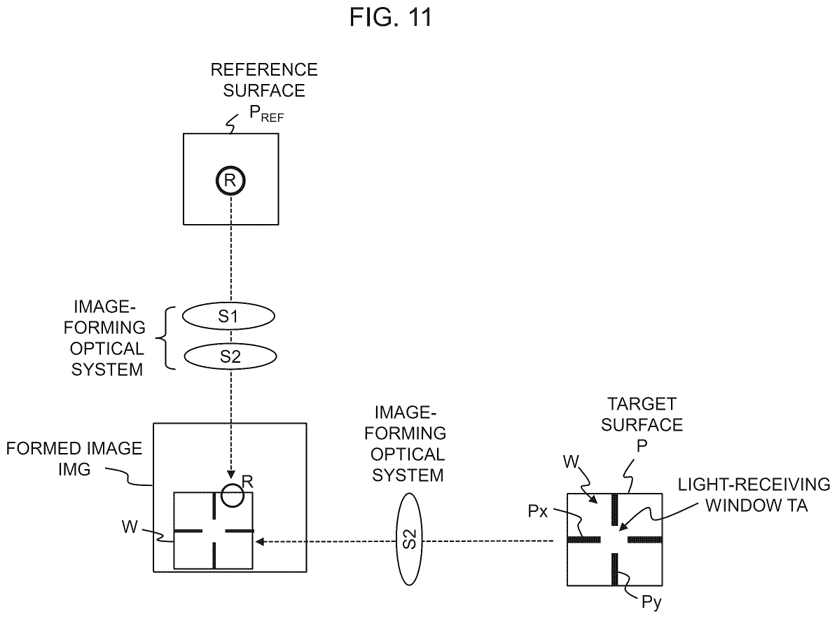

As illustrated in FIG. 11, the reference figure R of the reference surface P_{REF} is a circular, and the predetermined figure W of the target surface P has a shape that allows extraction of each figure even if the reference figure R and the predetermined figure W overlap one another. Desirably, the predetermined figure W is displayed on the entire surface of the target surface P. More specifically, the predetermined figure W is composed of four line segments extending radially and evenly around the light-receiving window TA. As an example, the predetermined figure W is composed of a line Px in the x-direction or horizontal direction and a line Py in the y direction or vertical direction, wherein each of the lines Px and Py is divided by the light-receiving window TA into two line segments. Accordingly, the location of the light receiving window TA can be identified by extracting the straight lines of the predetermined figure W from the image acquired by the image sensor 101. The circular reference figure R can be easily extracted no matter how it overlaps with the predetermined figure W composed of straight lines.

The control operation of the processor 103B is substantially equivalent to the optical axis adjustment flow illustrated in FIG. 9. That is, the processor 103B acquires the captured image of the reference surface P_{REF} and the target surface P at the image analysis timing, and extracts from the acquired image the circular reference figure R and the predetermined figure W consisting of four line segments. As already explained, the reference location r and the feature location w are detected geometrically from the extracted reference figure R and the predetermined figure W, respectively. The deflector 102 is controlled to eliminate the location difference between the reference location r and the feature location w, In this manner, the optical axis adjustment is performed rapidly and precisely.

### 3.2) Second Example

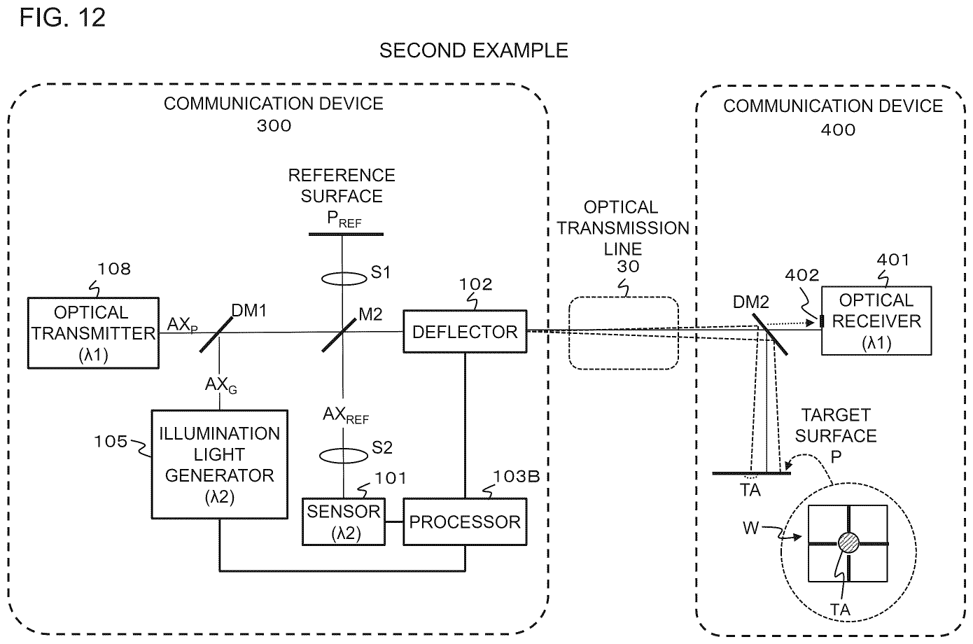

Referring to FIG. 12, an optical axis adjustment apparatus according to the second example of the present invention will be described. The configuration of the second example is basically the same as that of the first example. Accordingly, blocks similar to those of the first example are denoted by the same reference numerals and their detailed descriptions are omitted.

In FIG. 12, it is assumed that a transmitting communication device 300 and a receiving communication device 400 are optically connected by an optical transmission line 30. Here, the optical transmission line 30 in the present example may be a spatial link for optical transmission in the atmosphere without using optical fiber or the like. Therefore, in order to achieve stable spatial transmission between the communication devices 300 and 400, which are spatially separated, it is necessary to precisely align the optical axes of the communication devices 300 and 400.

The communication device 300 has the same configuration as the optical axis adjustment apparatus 10A1 according to the first example illustrated in FIG. 10, except for the addition of an optical transmitter 108 that transmits a laser beam as a signal light beam of wavelength λ1. Accordingly, the same reference numerals are used and detailed descriptions are omitted.

The communication device 400 includes: the target surface P; a dichroic mirror DM2; and an optical receiver 401. The target surface P displays the predetermined figure W on its entire surface as described in the first example (see FIG. 11). The dichroic mirror DM2 has a characteristic of transmitting the signal light beam of wavelength λ1 and reflecting the illumination light beam of wavelength λ2. The optical receiver 401 is provided with the light receiving surface 402 of a photodetector, which receives the signal light beam of wavelength λ1. If the optical axis adjustment of the communication device 300 is completed, the light receiving surface 402 is correctly irradiated with the signal light beam. In the present example, the light receiving surface 402 of the optical receiver 401 and the light receiving window TA of the target surface P are placed separately, and the position of the light receiving surface 402 corresponds to the position of the light receiving window TA of the target surface P.

The optical axis adjustment between the communication devices 300 and 400 has been described as in the first example. That is, the processor 103B of the communication device 300 acquires the captured image of the reference surface P_{REF} and the target surface P at the image analysis timing, and extracts from the captured image the circular reference figure R and the predetermined figure W consisting of four line segments. Hereafter, the reference location r and the feature location w are detected geometrically from the extracted reference figure R and the predetermined figure W, respectively. Further, the optical axis adjustment is executed by controlling the deflector 102 to cancel the location difference between the reference location r and the feature location w.

In this manner, the above-described optical axis adjustment is executed between communication devices 300 and 400, resulting in stable spatial transmission between them. The optical axis adjustment apparatus according to the present example is suitable for accurate optical axis adjustment between communication devices 300 and 400, which are spatially separated. In particular, accurate optical axis alignment is required in optical communication systems such as quantum key distribution (QKD) system using very weak signal light of one photon or less. Even in such optical communication systems, the optical axis adjustment apparatus enables stable spatial transmission.

### 3.3) Other Examples

In the first and second examples as described above, the illumination light generator 105 emits an illumination light beam of wavelength λ2, which is then reflected by the dichroic mirror DM1 in the direction of the primary optical axis AX_{P}, thereby illuminating the reference surface P_{REF} and the target surface P. However, the present invention is not limited to such an illumination method. Light of wavelength λ2 from the reference surface P_{REF} and the target surface P may form an image on the image sensor 101. Other examples will be described below.

### Third Example

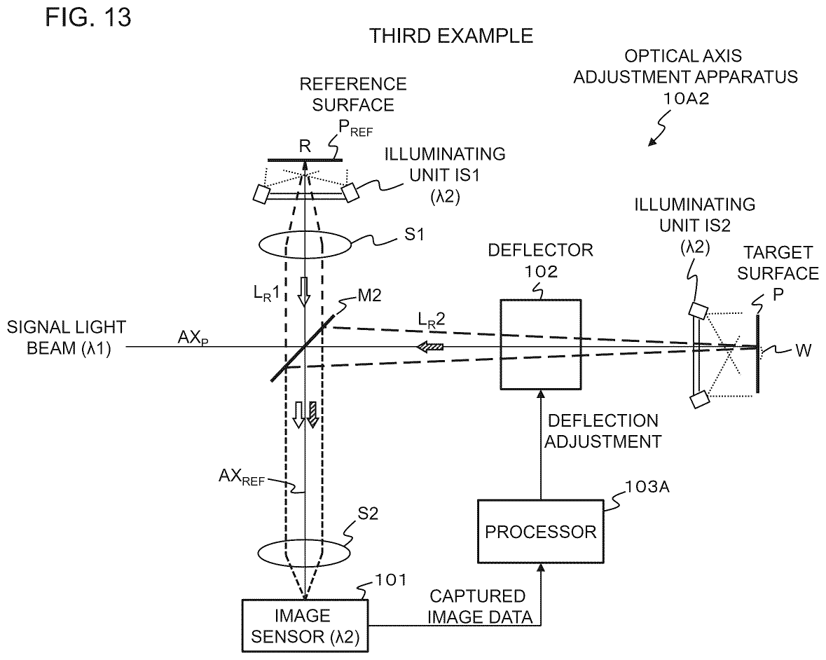

As illustrated in FIG. 13, the optical axis adjustment apparatus 10A2 according to a third example is provided with illuminating units IS1 and IS2 instead of the illumination light generator 105 and dichroic mirror DM1 of the optical axis adjustment apparatus 10A1 according to the first example. The illuminating unit IS1 includes an array of a plurality of light emitting diodes (LEDs) of wavelength λ2, which illuminates the reference surface P_{REF} with illumination light of wavelength λ2. Similarly, the illuminating unit IS2 includes an array of a plurality of LEDs of wavelength λ2, which illuminates the target surface P with illumination light of wavelength λ2.

Thus, light of wavelength λ2 from the reference surface P_{REF} and the target surface P can be imaged on the image sensor 101. The remaining configuration and operation are the same as those in the example embodiments and examples as described above. Accordingly, blocks similar to those of the first and second example embodiments are denoted by the same reference numerals and their detailed descriptions are omitted.

### Fourth Example

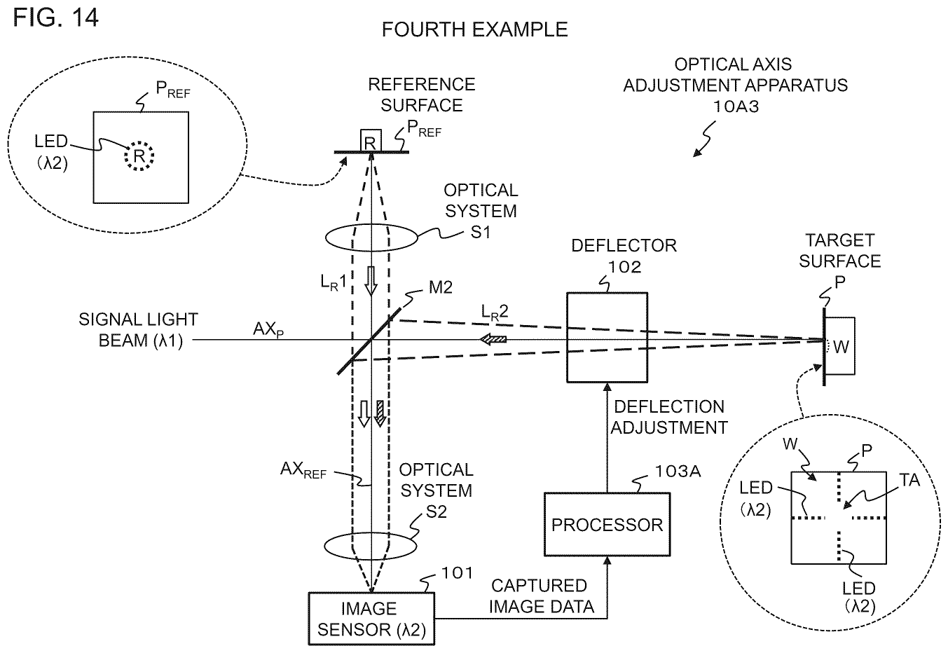

As illustrated in FIG. 14, an optical axis adjustment apparatus 10A3 according to the fourth example is not provided with any means of illuminating the reference surface P_{REF} and the target surface P as in the first to third examples. Instead of such illumination means, the optical axis adjustment apparatus 10A3 is provided with a light emission device which emits light of wavelength λ2 to display both the reference figure R and the predetermined figure W or only the predetermined figure W.

In FIG. 14, a plurality of light emitting elements (here, LEDs (light-emitting diodes)) are arranged in the shape of the reference figure R on the reference surface P_{REF}. Each light emitting element of the reference surface P_{REF} emits light of wavelength λ2 to display the reference figure R as a whole. In addition, a plurality of light-emitting elements are arranged in the shape of the predetermined figure W on the target surface P. Each light-emitting element of the target surface P emits light of wavelength λ2 to display the predetermined figure W as a whole. Instead of an array of multiple light-emitting elements, a light-shielding mask with a transparent portion of the reference figure R or the predetermined figure W may be placed in front of a light source of the wavelength λ2.

The light emitting device of either the reference surface P_{REF} or the target surface P may be made to emit light. In particular, it is preferable that the light emitting device of the target surface P is made to emit light. This is suitable for a communication system in which communication devices are spatially separated from each other, as in the second example. The reason is that image capturing of the target surface P can be performed with light of higher intensity than the reflected light L_{R}1.

### <Deflector>

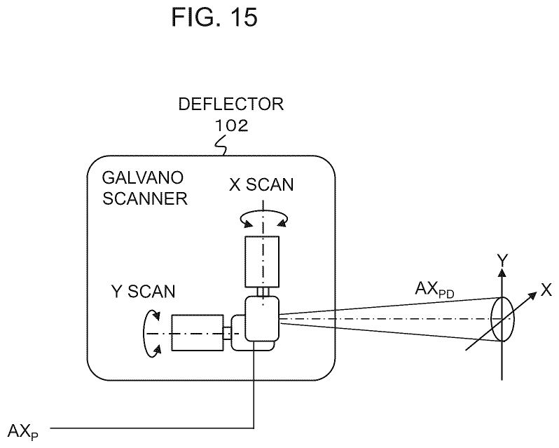

The deflector 102 used in each of the above-described example embodiments and examples can be mechanically driven, acousto-optic, or electro-optic. FIG. 15 illustrates a galvanometer scanner as a mechanically driven deflector 102. As is well known, the galvanometer scanner may be used as the deflector 102, which performs X/Y scanning of a light beam by rotating two reflectors.

### 4. Additional Statements

The present invention may be embodied in other specific forms without departing from the spirit or essential characteristics thereof. The above-described illustrative embodiment and examples are therefore to be considered in all respects as illustrative and not restrictive, the scope of the invention being indicated by the appended claims rather than by the foregoing description, and all changes which come within the meaning and range of equivalency of the claims are therefore intended to be embraced therein. Part or all of the above-described illustrative embodiments can also be described as, but are not limited to, the following additional statements.

### Additional Statement 1

An optical axis adjustment apparatus comprising:
a deflector that deflects an incoming light beam to output an outgoing light beam to a target surface, wherein the target surface includes a predetermined light-receiving location that is indicated by a predetermined figure displayed on the target surface;
an image sensor that captures the target surface through the deflector to output a captured image of the target surface; and
at least one processor configured to:
   extract the predetermined figure from the captured image;
   detect the predetermined light-receiving location from the predetermined figure; and
   adjust a deflection of the deflector so that the predetermined light-receiving location coincides with a reference location on the captured image of the target surface, wherein the reference location corresponds to a location of a primary optical axis of the incoming light beam on the captured image.

### Additional Statement 2

The optical axis adjustment apparatus according to claim 1, wherein the at least one processor is further configured to previously set the reference location at a predetermined position on the captured image.

### Additional Statement 3

The optical axis adjustment apparatus according to claim 2, further comprising an image-forming optical system provided between the deflector and the image sensor, wherein the captured image of the target surface is formed on the image sensor through the image-forming optical system, wherein the image sensor is a two-dimensional sensor.

### Additional Statement 4

The optical axis adjustment apparatus according to claim 3, further comprising a mirror member placed at an intersection of the primary optical axis and a reference optical axis orthogonal to the primary optical axis,
wherein the image-forming optical system is placed between the mirror member and the image sensor, and
wherein the mirror member has a characteristic that the incoming light beam of a first wavelength is transmitted and other light of a second wavelength different from the first wavelength is reflected toward the image sensor, wherein light of the second wavelength enters the mirror member from the target surface.

### Additional Statement 5

The optical axis adjustment apparatus according to claim 1, further comprising an illumination light source that illuminates the target surface with illumination light different in wavelength from the incoming light beam.

### Additional Statement 6

The optical axis adjustment apparatus according to claim 1, wherein the predetermined figure on the target surface is shaped by light-emitting elements that emits light different in wavelength from the incoming light beam.

### Additional Statement 7

The optical axis adjustment apparatus according to claim 1, further comprising a reference surface including a reference figure that indicates the reference location,
wherein the image sensor further captures the reference surface, and
wherein the at least one processor is further configured to:
   extract the reference figure from the captured image; and
   detect the reference location from the reference figure.

### Additional Statement 8

The optical axis adjustment apparatus according to claim 7, further comprising an image-forming optical system through which the captured image of the target surface and the reference surface is formed on the image sensor, wherein the image sensor is a two-dimensional sensor.

### Additional Statement 9

The optical axis adjustment apparatus according to claim 8, wherein the image-forming optical system includes a mirror member, a first optical system and a second optical system,
wherein the mirror member is placed at an intersection of the primary optical axis and a reference optical axis orthogonal to the primary optical axis,
wherein the mirror member, the first optical system, the second optical system, the reference surface and the image sensor are place on the reference optical axis, wherein the first optical system is placed between the mirror member and the reference surface and the second optical system is placed between the mirror member and the image sensor, and
wherein the mirror member has a characteristic that the incoming light beam of a first wavelength is transmitted and nearly half of light of a second wavelength different from the first wavelength is transmitted whereas the remaining half is reflected towards the image sensor, wherein the light of the second wavelength from the reference surface is transmitted to the image sensor.

### Additional Statement 10

The optical axis adjustment apparatus according to claim 7, further comprising an illumination light source that illuminates the target surface and the reference surface with illumination light different in wavelength from the incoming light beam.

### Additional Statement 11

The optical axis adjustment apparatus according to claim 1, wherein at least the predetermined figure of the predetermined figure on the target surface and the reference figure on the reference surface is shaped by light-emitting elements that emits light different in wavelength from the incoming light beam.

### Additional Statement 12

An optical communication system comprising:
a first communication device including the optical axis adjustment apparatus according to claim 1; and
a second communication device including the target surface, wherein the first and second communication devices are connected through a spatial link as an optical transmission line.

### Additional Statement 13

The optical communication system according to claim 12, wherein the predetermined figure is shaped by light-emitting elements that emits light different in wavelength from the incoming light beam.

### Additional Statement 14

An optical axis adjustment method in an optical axis adjustment apparatus including: a deflector that deflects an incoming light beam to output an outgoing light beam to a target surface, wherein the target surface includes a predetermined light-receiving location that is indicated by a predetermined figure displayed on the target surface; an image sensor that captures the target surface through the deflector to output a captured image of the target surface; and at least one processor configured to control the deflector based on the captured image, the method comprising:
extracting the predetermined figure from the captured image;
detecting the predetermined light-receiving location from the predetermined figure; and
adjusting a deflection of the deflector so that the predetermined light-receiving location coincides with a reference location on the captured image of the target surface, wherein the reference location corresponds to a location of a primary optical axis of the incoming light beam on the captured image.

### Additional Statement 15

The optical axis adjustment method according to claim 14, wherein the reference location is previously set at a predetermined position on the captured image by the at least one processor.

### Additional Statement 16

The optical axis adjustment method according to claim 14, wherein the optical axis adjustment apparatus further includes a reference surface including a reference figure that indicates the reference location, wherein the image sensor further captures the reference surface, the method further comprising:
extracting the reference figure from the captured image; and
detecting the reference location from the reference figure.

### Additional Statement 17

A non-transitory recording medium storing a computer-readable program for an optical axis adjustment apparatus including: a deflector that deflects an incoming light beam to output an outgoing light beam to a target surface, wherein the target surface includes a predetermined light-receiving location that is indicated by a predetermined figure displayed on the target surface; an image sensor that captures the target surface through the deflector to output a captured image of the target surface; and at least one processor configured to control the deflector based on the captured image, the program comprising instructions to:
extract the predetermined figure from the captured image;
detect the predetermined light-receiving location from the predetermined figure; and
adjust a deflection of the deflector so that the predetermined light-receiving location coincides with a reference location on the captured image of the target surface, wherein the reference location corresponds to a location of a primary optical axis of the incoming light beam on the captured image.

### Additional Statement 18

The non-transitory recording medium according to claim 17, wherein the reference location is previously set at a predetermined position on the captured image by the at least one processor.

### Additional Statement 19

The non-transitory recording medium according to claim 17, wherein the optical axis adjustment apparatus further includes a reference surface including a reference figure that indicates the reference location, wherein the image sensor further captures the reference surface, the program further comprising instructions to:
extract the reference figure from the captured image; and
detect the reference location from the reference figure.

The present invention is applicable to optical systems and optical communication devices that require optical axis adjustment.

1. An optical axis adjustment apparatus comprising:
a deflector that deflects an incoming light beam to output an outgoing light beam to a target surface, wherein the target surface includes a predetermined light-receiving location that is indicated by a predetermined figure displayed on the target surface;
an image sensor that captures the target surface through the deflector to output a captured image of the target surface; and
at least one processor configured to:
extract the predetermined figure from the captured image;
detect the predetermined light-receiving location from the predetermined figure; and
adjust a deflection of the deflector so that the predetermined light-receiving location coincides with a reference location on the captured image of the target surface, wherein the reference location corresponds to a location of a primary optical axis of the incoming light beam on the captured image.

2. The optical axis adjustment apparatus according to claim 1, wherein the at least one processor is further configured to previously set the reference location at a predetermined position on the captured image.

3. The optical axis adjustment apparatus according to claim 2, further comprising an image-forming optical system provided between the deflector and the image sensor, wherein the captured image of the target surface is formed on the image sensor through the image-forming optical system, wherein the image sensor is a two-dimensional sensor.

4. The optical axis adjustment apparatus according to claim 3, further comprising a mirror member placed at an intersection of the primary optical axis and a reference optical axis orthogonal to the primary optical axis,
wherein the image-forming optical system is placed between the mirror member and the image sensor, and
wherein the mirror member has a characteristic that the incoming light beam of a first wavelength is transmitted and other light of a second wavelength different from the first wavelength is reflected toward the image sensor, wherein light of the second wavelength enters the mirror member from the target surface.

5. The optical axis adjustment apparatus according to claim 1, further comprising an illumination light source that illuminates the target surface with illumination light different in wavelength from the incoming light beam.

6. The optical axis adjustment apparatus according to claim 1, wherein the predetermined figure on the target surface is shaped by light-emitting elements that emits light different in wavelength from the incoming light beam.

7. The optical axis adjustment apparatus according to claim 1, further comprising a reference surface including a reference figure that indicates the reference location,
wherein the image sensor further captures the reference surface, and
wherein the at least one processor is further configured to:
extract the reference figure from the captured image; and
detect the reference location from the reference figure.

8. The optical axis adjustment apparatus according to claim 7, further comprising an image-forming optical system through which the captured image of the target surface and the reference surface is formed on the image sensor, wherein the image sensor is a two-dimensional sensor.

9. The optical axis adjustment apparatus according to claim 8, wherein the image-forming optical system includes a mirror member, a first optical system and a second optical system,
wherein the mirror member is placed at an intersection of the primary optical axis and a reference optical axis orthogonal to the primary optical axis,
wherein the mirror member, the first optical system, the second optical system, the reference surface and the image sensor are place on the reference optical axis, wherein the first optical system is placed between the mirror member and the reference surface and the second optical system is placed between the mirror member and the image sensor, and
wherein the mirror member has a characteristic that the incoming light beam of a first wavelength is transmitted and nearly half of light of a second wavelength different from the first wavelength is transmitted whereas the remaining half is reflected towards the image sensor, wherein the light of the second wavelength from the reference surface is transmitted to the image sensor.

10. The optical axis adjustment apparatus according to claim 7, further comprising an illumination light source that illuminates the target surface and the reference surface with illumination light different in wavelength from the incoming light beam.

11. The optical axis adjustment apparatus according to claim 7, wherein at least the predetermined figure of the predetermined figure on the target surface and the reference figure on the reference surface is shaped by light-emitting elements that emits light different in wavelength from the incoming light beam.

12. An optical communication system comprising:
a first communication device including the optical axis adjustment apparatus according to claim 1; and
a second communication device including the target surface, wherein the first and second communication devices are connected through a spatial link as an optical transmission line.

13. The optical communication system according to claim 12, wherein the predetermined figure is shaped by light-emitting elements that emits light different in wavelength from the incoming light beam.

14. An optical axis adjustment method in an optical axis adjustment apparatus including: a deflector that deflects an incoming light beam to output an outgoing light beam to a target surface, wherein the target surface includes a predetermined light-receiving location that is indicated by a predetermined figure displayed on the target surface; an image sensor that captures the target surface through the deflector to output a captured image of the target surface; and at least one processor configured to control the deflector based on the captured image, the method comprising:
extracting the predetermined figure from the captured image;
detecting the predetermined light-receiving location from the predetermined figure; and
adjusting a deflection of the deflector so that the predetermined light-receiving location coincides with a reference location on the captured image of the target surface, wherein the reference location corresponds to a location of a primary optical axis of the incoming light beam on the captured image.

15. The optical axis adjustment method according to claim 14, wherein the reference location is previously set at a predetermined position on the captured image by the at least one processor.

16. The optical axis adjustment method according to claim 14, wherein the optical axis adjustment apparatus further includes a reference surface including a reference figure that indicates the reference location, wherein the image sensor further captures the reference surface, the method further comprising:
extracting the reference figure from the captured image; and
detecting the reference location from the reference figure.

17. A non-transitory recording medium storing a computer-readable program for an optical axis adjustment apparatus including: a deflector that deflects an incoming light beam to output an outgoing light beam to a target surface, wherein the target surface includes a predetermined light-receiving location that is indicated by a predetermined figure displayed on the target surface; an image sensor that captures the target surface through the deflector to output a captured image of the target surface; and at least one processor configured to control the deflector based on the captured image, the program comprising instructions to:
extract the predetermined figure from the captured image;
detect the predetermined light-receiving location from the predetermined figure; and
adjust a deflection of the deflector so that the predetermined light-receiving location coincides with a reference location on the captured image of the target surface, wherein the reference location corresponds to a location of a primary optical axis of the incoming light beam on the captured image.

18. The non-transitory recording medium according to claim 17, wherein the reference location is previously set at a predetermined position on the captured image by the at least one processor.

19. The non-transitory recording medium according to claim 17, wherein the optical axis adjustment apparatus further includes a reference surface including a reference figure that indicates the reference location, wherein the image sensor further captures the reference surface, the program further comprising instructions to:
extract the reference figure from the captured image; and
detect the reference location from the reference figure.
